(19) United States
(12) Patent Application Publication
(10) Pub. No.: US 2026/0205920 A1
(43) Pub. Date: Jul. 16, 2026

(54) METHODS AND SYSTEMS FOR ESTABLISHING SECURITY WHEN SWITCHING BETWEEN PC5 AND UU COMMUNICATION PATHS FOR PROXIMITY BASED SERVICES

(71) Applicant: ZTE CORPORATION, Shenzhen, Guangdong (CN)

(72) Inventors: Yuze LIU, Shenzhen (CN); Shilin YOU, Shenzhen (CN); Zhen XING, Shenzhen (CN); Peilin LIU, Shenzhen (CN); Wei MA, Shenzhen (CN)

(21) Appl. No.: 19/135,514

(22) PCT Filed: Dec. 23, 2022
(86) PCT No.: PCT/CN2022/141539

§ 371 Date: Jun. 4, 2025

(51) Int. Cl. H04W 40/34; H04W 12/106; H04W 76/14; H04W 92/18

(52) U.S. Cl. CPC H04W 40/34; H04W 12/106; H04W 76/14; H04W 92/18

(57) ABSTRACT

Methods and systems for establishing and maintaining security for communications when switching paths for the communications are disclosed herein. In one embodiment, a method performed by a first wireless communication device includes: determining whether a service is allowed to switch between at least two different communication paths based on a path switching policy associated with the service; and when the service is allowed to switch between the at least two different communication paths, setting a signaling integrity protection policy for the service to REQUIRED.

### CROSS-REFERENCE TO RELATED APPLICATION

The present disclosure is a national stage filing under 35 U.S.C. § 371 of international application number PCT/CN2022/141539, filed Dec. 23, 2022, the content of which is incorporated herein by reference in its entirety.

### TECHNICAL FIELD

The disclosure relates generally to wireless communications and, more particularly, to methods and systems for establishing security for wireless communications when switching between PC5 and Uu communication paths for proximity based services.

### BACKGROUND

Current wireless communications systems (e.g., New Radio (NR), 5G, etc.) can support communications between two or more wireless devices via either the PC5 path or the Uu path. As known in the art, the PC5 path or interface enables direct communications between wireless devices without going through an intermediate communication node or network. For example, direct communications between vehicles and other devices (e.g., V2V, V2I) use the PC5 interface, which allows the vehicles and other wireless communication devices, collectively referred to as User Equipment (UE) herein, to directly communicates with each other over a direct channel. In this case, communication with a base station or other intermediate node or network is not required.

In 3GPP RAN specifications, the term “sidelink” is used to refer to the direct communication over the PC5 interface. As also known in the art, the Uu path or interface is an air interface between a UE and Random Access Network (RAN).

Current systems also path switching between PC5 and Uu paths for UE's exchanging signaling and data associated with proximity services. Proximity services (ProSe) refers to a D2D (Device-to-Device) technology that allows wireless communication devices to detect each other and to communicate directly. In comparison to existing D2D and proximity networking technologies, ProSe offers a number of distinct benefits including better scalability, manageability, privacy, security and battery-efficiency. For example, mobile operators can leverage ProSe to offer a range of B2B, B2B2C and B2C services that rely on proximity, including advertising, social networking, gaming, relaying traffic for wearables and V2X (Vehicle-to-Everything) connectivity, among others. Additonally, public safety communications can greatly benefit from direct communication capability that does not require any infrastructure and allows first responders to communicate effectively. Proximity based direct communications can be used when infrastructure-based communication is not available or when policy dictates that direct communication should be used.

A Path switching policy is associated with each ProSe service and is used to indicate which paths are permitted for each ProSe service (i.e. PC5 permitted, or Uu permitted, or both PC5 and Uu permitted). Based on the path switching policy, a UE may establish a PDU session via Uu connection (a.k.a., Uu path) or a PC5 connection (a.k.a., PC5 path) in a target path and switch the traffic from a source path to the target path. The service continuity during path switching can be achieved by the application layer mechanism.

Additionally, UEs can negotiate with each other over an existing PC5 connection to determine whether and which ProSe services can be switched taking into account, e.g., their respective path switching policies, availability of the Uu path, signal quality or amount of traffic on one path, distance between UEs (longer distance favors Uu path), etc. When a Source UE requests to switch paths from the PC5 path to the Uu path, for example, or vice versa, for a specific ProSe service, the Target UE can confirm if the path can be switched or not based on the path switching policy for that particular ProSe service, among other factors such as those mentioned above. For example, if a first UE requests switching from the PC5 path to the Uu path to perform a ProSe service with a second UE, the second UE may notify the first UE that it accepts or rejects the path switching request based on factors such as congestion control, mobility restrictions, distance between UE's, signal quality on the PC5 and Uu paths, etc.

FIG. 1A illustrates a high level network architecture of a conventional Uu path that can be used by two UEs 102 and 104 to communicate with each other. As shown in FIG. 1A, a first UE 102 communicates with the second UE 104 via a path that includes a first Uu interface that couples the first UE 102 to a first NG-RAN node 106, a 5G Core network 110, a data network 112 (if necessary), and a second Uu interface that couples a second NG-RAN node 108 to the second UE2 104.

FIG. 1B illustrates a high level network architecture of a conventional PC5 path that can be used by the two UEs 102 and 104 to perform sidelink communications with each other. As shown in FIG. 1B, in this scenario, the UEs 102 and 104 can communication directly with each other without the need for any intermediate nodes (e.g., a base station) or other network functions such as elements 106, 108, 110 and 112 shown in FIGS. 1A and 1B.

In order to perform communications via a PC5 path or interface, a UE can be provisioned with the following:
a list of authorized services, e.g., V2X services, which can be provided by Provider Service Identifiers (PSIDs) or Intelligent Transport Systems Application Identifiers (ITS-AIDs) of the applications, with Geographical Area(s) and their respective security policies which indicate the following:
Signaling integrity protection: REQUIRED/PREFERRED/NOT NEEDED
Signaling confidentiality protection: REQUIRED/PREFERRED/NOT NEEDED
User plane integrity protection: REQUIRED/PREFERRED/NOT NEEDED
   User plane confidentiality protection: REQUIRED/PREFERRED/NOT NEEDED As used herein “signaling integrity protection” means protection from corruption, tampering and/or unintended alteration of a signal and data carried therein. “Signaling confidentiality protection” means protection of the confidentiality of information contained in a signal, which can be protected by encryption, for example. “User plane integrity protection” refers to protection from corruption, tampering and/or unintended alteration of UP data and signaling. “User plane confidentiality protection” means protection of the confidentiality of UP data. Additionally, the term “REQUIRED” means that the indicated protection must be provided for a communication or link to be established. The term “PREFERRED” means that the indicated protection should be provided when possible but does not need to be provided if other factors weigh against providing the indicated protection. The term “NOT NEEDED” means that the indicated protection can be omitted regardless of other factors.

If the security policy for a particular service or application is “NOT NEEDED” over the PC5 path, when switching from the PC5 path to the Uu path, the UEs will establish a new connection with no security, which can result in communications being intercepted, tampered with or corrupted during UE negotiations, and the peer UE may not be able to receive the correct information to perform the path switching. Currently, there are no methods for solving these security issues. Additionally, there are no methods for ensuring that security policies remain consistent when switching paths from the PC5 path to the Uu path, and vice versa. Therefore, existing methods for switching communication paths are not entirely satisfactory.

### SUMMARY OF THE INVENTION

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In one embodiment, a method performed by a wireless communication device includes: determining whether a service is allowed to switch between at least two different communication paths based on a path switching policy associated with the service; and if the service is allowed to switch between the at least two different communication paths, setting a signaling integrity protection policy for the service to REQUIRED. In some embodiments, the service comprises a ProSe service. In further embodiments, the at least two communication paths comprise a PC5 path and a Uu path.

In another embodiment, a method performed by a wireless communication device includes: when the wireless communication device desires to switch from a Uu path to a PC5 path for a service, if the wireless communication device has an active the User Plane (UP) security protection for the service over the Uu path, the wireless communication device sets the UP security protection policy for the service to REQUIRED for the PC5 path, or if the wireless communication device does not have an active UP security protection for the service over the Uu path, the wireless communication device sets the UP security protection policy for the service to NOT NEEDED for the PC5 path. In this way, the UP security protection policy for the service remains consistent when switching from Uu path to the PC5 path. In accordance with some embodiments, the UP security protection policy includes at least one or both of a UP integrity protection policy and UP confidentiality protection policy.

In a further embodiment, a method performed by a wireless communication device includes: when the wireless communication device desires to switch paths from a PC5 path to a Uu path for one or more services, the wireless communication device informs the network that the PDU session will be switched from a PC5 path and also informs the network of the UP security state (e.g., active or inactive) for the PC5 path. The network (e.g., an SMF as described in further detail below), will then take this information into consideration to grant or deny the PDU session request via the Uu path. For example, the network may deny the PDU session request if the UP security state for the PC5 path cannot be maintained due to lack of available resources, traffic congestion, Quality of Service (QoS) requirements cannot be fulfilled, etc.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1A illustrates a high-level network architecture of a conventional communications system wherein two or more UEs can communicate with each other via Uu paths.

FIG. 1B illustrates a high-level network architecture of a conventional communications system wherein two or more UEs can perform sidelink communications with each other via a PC5 path.

FIG. 2 illustrates a procedure for negotiating and establishing security level for communications between two UE's over a PC5 link during the PC5 connection procedure, in accordance with some embodiments of the present disclosure.

FIG. 3 illustrates a high-level process flow of a process for establishing a Uu connection for communications between two UEs and thereafter switching from the Uu path to a PC5 path for direct communications between the two UEs, in accordance with some embodiments.

FIG. 4 illustrates a high-level process flow of a process for establishing a PC5 connection for communications between two UEs, including negotiations between the two UEs, and thereafter switching from the PC5 path to a Uu path for direct communications between the two UEs, in accordance with some embodiments.

FIG. 5 illustrates a block diagram of a wireless communication node configured to perform the methods disclosed herein, in accordance with various embodiments of the invention.

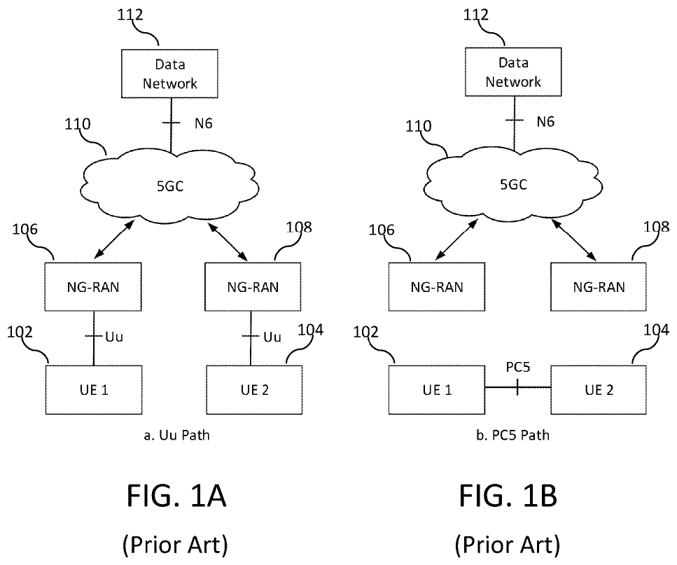

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

In some embodiments described herein, the term “coupled,” “connected,” and the like, may be used herein to indicate a connection, although not necessarily directly, and may include wired and/or wireless connections.

In some embodiments, the non-limiting terms wireless communication device or a user equipment (UE) are used interchangeably. The term “UE” can refer to any type of wireless device capable of communicating with a network node and/or another UE over radio signals. In some embodiments, the UE may be a machine and/or a vehicle (e.g., V2X vehicle having thereon a V2X application). The UE herein can by any type of communication device capable of communicating with another UE, an application server, a network node, a server and/or other node, via a wired connection and/or a wireless connection. The UE may be a radio communication device such as, an initiating UE, a remote UE, a target device, device to device (D2D) UE, machine type UE or UE capable of machine to machine communication (M2M), low-cost and/or low-complexity UE, a sensor equipped with UE, tablet, mobile terminals, smart phone, laptop embedded equipment (LEE), laptop mounted equipment (LME), USB dongles, Customer Premises Equipment (CPE), an Internet of Things (IoT) device, or a Narrowband IoT (NB-IOT) device etc.

In some embodiments, the term “node” is used herein and can be any kind of network node, such as, an Access and Mobility Function (AMF) node, a session management node (e.g., session management function (SMF) node), an access function (AF) node, a user plane function (UPF) node, a policy control function (PCF) node, or any network node. In some embodiments, the network node may be, for example, a subscriber database node, a core network node, a Fifth Generation (5G) and/or New Radio (NR) network node, an Evolved Packet System (EPS) node, an Internet Protocol (IP) Multimedia Subsystem (IMS) node, a Network Function (NF) node, a network repository function (NRF) node, a unified data repository (UDR) node, a unified data management (UDM) node, a Network Exposure Function (NEF) node, a home subscriber server (HSS) node, a home location register (HLR) node, etc.

In yet further embodiments, the network node may include any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, integrated access and backhaul (IAB), donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc.

A node may include physical components, such as processors, allocated processing elements, or other computing hardware, computer memory, communication interfaces, and other supporting computing hardware. The node may use dedicated physical components, or the node may be allocated use of the physical components of another device, such as a computing device or resources of a datacenter, in which case the node is said to be virtualized. A node may be associated with multiple physical components that may be locate either in one location, or may be distributed across multiple locations. These components may be used to implement and/or support any of the path selection techniques and arrangements disclosed herein.

In some embodiments, the terms “path,” “interface,” “reference point” and “link” may be used interchangeably. In some embodiments, the terms “parameter” and “information” may be used interchangeably.

It should also be understood that Uu and PC5 interfaces may be given modified names in the future and the techniques disclosed herein are not intended to be limited to the particular names given these interfaces today.

Layer-2 may include radio resource control (RRC), packet data convergence protocol (PDCP), radio link control (RLC) and medium access control (MAC).

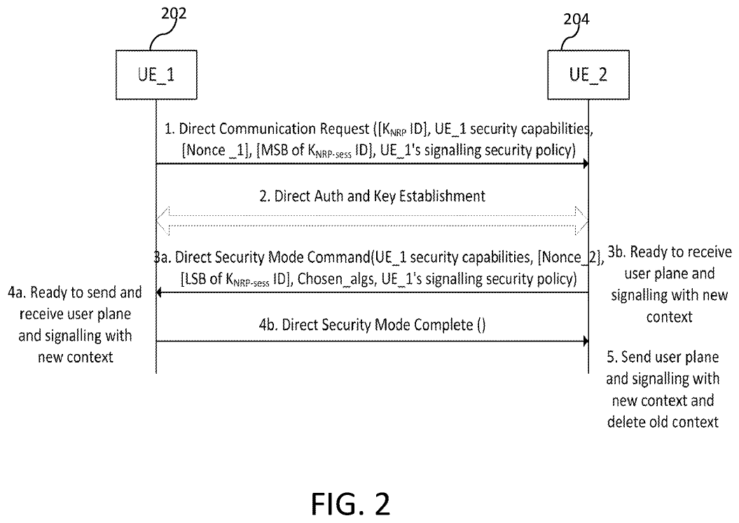

Additionally, any two or more embodiments described in this disclosure may be combined with each other to achieve a combination of features and advantages associated with the two or more embodiments. Although the description herein may be explained in the context of proximity-based services (ProSe services), it should be understood that the principles may also be applicable and beneficial to other types of services, applications and communications. FIG. 2 illustrates a procedure for negotiating and establishing security level for communications between two UE's over a PC5 link during the PC5 connection procedure, in accordance with some embodiments of the present disclosure. In a first step, a first UE 202 (hereinafter “UE_1”) sends a Direct Communication Request (DCR) message to a second UE 204 (hereinafter “UE_2”). In accordance with some embodiments, the DCR message includes UE_1's security capabilities (e.g., a list of security algorithms that UE_1 can accept for this connection) and UE_1's signaling security policy. The DCR message can include other parameters such as Nonce_1 (for session key K_{NRP-sess} generation), and the most significant 8-bits of the K_{NRP-sess} ID in the DCR message if UE_1's signaling integrity protection policy is either “REQUIRED” or “PREFERRED”. The most significant 8-bits of the KNRP-sess ID shall be chosen such that UE_1 will be able to locally identify a security context that is created by this procedure using the KNRP-sess ID. Additionally, if UE_1 can switch from a PC5 path to a Uu path, or vice versa, for the ProSe service for which communications with UE_2 is being request, UE_1 will set its signaling integrity protection policy for the ProSe service to “REQUIRED”.

At step 2, UE_2 can reject the Direct Communication Request if UE_1's signaling security policy is “NOT NEEDED” while UE_2's security policy is “REQUIRED,” or vice versa. Otherwise, UE_2 may initiate a Direct Authentication and Key Establishment procedure with UE_1. If the Direct Authentication and Key Establishment procedure is initiated, the two UEs can authenticate each other using the information exchanged in Key_Est_Info contained in the DCR message, where the used authentication method is application-specific.

At step 3a, UE_2 sends a Direct Security Mode Command (DSMC) message to UE_1. This message can contain the MSB of a KNRP ID associated with UE_2 unless the Null integrity algorithm is selected by UE_2 and optionally Key_Est_Info if a fresh KNRP is to be generated, accordance with standard protocols. Additionally, the DSMC message can include a Chosen_algs parameter to include the selected integrity and confidentiality algorithm. A Non-Null security algorithm in the Chosen_algs indicates the corresponding security protection is activated and the security algorithm the UEs will use to protect the data in the message. A Null security algorithm in the Chosen_algs indicates the corresponding security protection is unprotected. The Chosen_algs may only indicate the use of the NULL integrity algorithm if UE_2's signaling integrity security policy is either NOT NEEDED or PREFERRED. UE_2 will also return the UE_1's security capabilities and UE_1's signaling security policy to provide protection against bidding down attacks. In the case that the NULL integrity algorithm is chosen, the NULL confidentiality algorithm shall also be chosen and UE_2 shall set the KNRP-sess ID of this security context to the all zero value. In accordance with some embodiments, if UE_2 can switch from a PC5 path to a Uu path, or vice versa, for the ProSe service for which communications is being requested, UE_2 will set its signaling integrity protection policy for the ProSe service to “REQUIRED”. Thus, for a particular ProSe service for which path switching is allowed, both UE_1 and UE_2 will set their respective signaling integrity protection policy to REQUIRED if not already set to this state, which will ensure that a secure PC5 link can be established between UE_1 and UE_2 and thereafter after protect signaling integrity between UE_1 and UE_2 during negotiations and path switching to the Uu path.

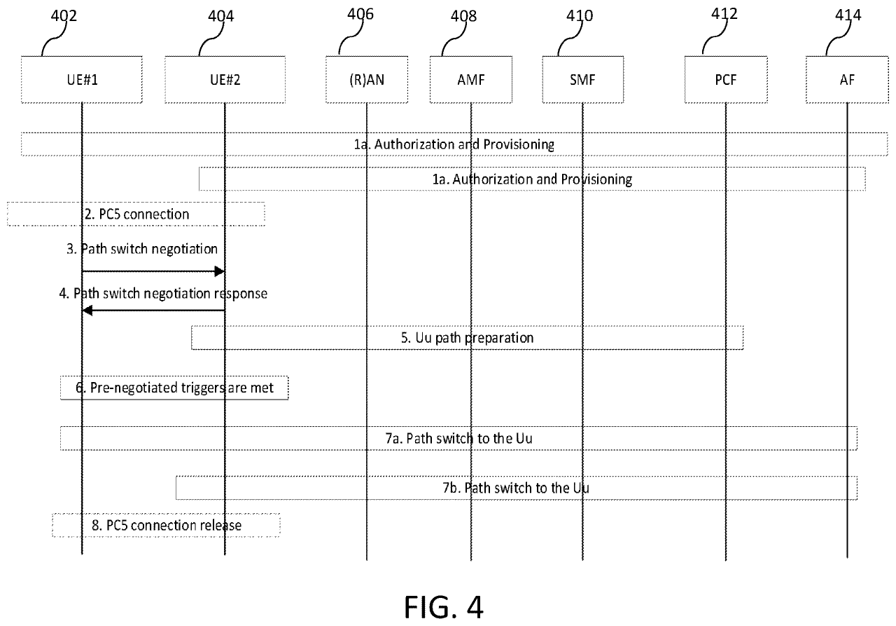

In some embodiments, both UE_1 and UE_2 can set its signaling integrity protection policy to REQUIRED by setting a bit in a memory of each UE. This set parameter can then be sent to AMF of a Core Network in a PDU Session Establishment message when switching from a PC5 path to a Uu path. Thereafter, the AMF can send the new parameter to the SMF of the Core Network, which will then decide whether to accept the PDU Session Establishment request based on the new parameter and other factors, as discussed in further detail below in connection with FIG. 4. In further embodiments, in addition to the signaling integrity protection policy, if a ProSe service is allowed to switch paths, UE_1 and UE_2 can also set the signaling confidentiality protection policy for the ProSe service over the PC5 interface to REQUIRED. In this case, both the signaling integrity protection policy and the signaling confidentiality protection policy is set to REQUIRED.

In some embodiments, the following procedures in step 3a will only be executed if the UE_2 decides to at least activate the integrity security protection for the connection: UE_2 shall also include Nonce_2 to allow a session key to be calculated, as well as the least significant 8-bits of K_{NRP-sess} ID in the messages. These bits are chosen so that UE_2 will be able to locally identify a security context that is created by this procedure. UE_2 shall calculate K_{NRP-Sess} from KNRP and both Nonce_1 and Nonce_2 and then derive the confidentiality (if applicable) and integrity keys based on the chosen algorithms. The lower layer shall be provided with the new security context and indication(s) to signal that the Direct Security Mode Command message needs integrity protection with the new security context and the signaling messages can be received using the new security context. The confidentiality key, NRPEK, shall be derived in this step if and only if signaling confidentiality protection is activated for this connection. The integrity protection key, NRPIK, shall be derived in this step if and only if signaling integrity protection is activated for this connection. In some embodiments, UE_2 can integrity protect the Direct Security Mode Command before sending it to UE_1.

At step 3b, UE_2 is then ready to receive signaling and messages protected with the new security context. In some embodiments, UE_2 can form a KNRP-sess ID from the most significant bits it received in step 1 and least significant bits it sent in step 3a, as described above.

At step 4, upon receiving the Direct Security Mode Command, the UE_1 will first check the Chosen_algs and shall accept the NULL integrity algorithm only if its security policy for signaling integrity protection is either NOT NEEDED or PREFERRED. Then UE_1 shall check the returned UE_1's security capabilities and UE_1's signaling security to avoid bidding down attacks if the NULL integrity algorithm is selected for signaling integrity protection. If the above check passes, UE_1 shall send an unprotected Direct Security Mode Complete message to UE_2. UE_1 shall set the K_{NRP-sess} ID of this security context to the all zero value.

When the condition of non-NULL integrity algorithm indicated in the Chosen_algs, UE_1 shall first check that the received LSB of K_{NRP-sess} ID is unique by checking that it has not been sent by another UE responding to this Direct Communication Request i.e. such that resulting K_{NRP-sess} ID is not already being used for another link. If the LSB of K_{NRP-sess} ID is not unique, then UE_1 shall respond with a Direct Security Mode Reject message including a cause value to specify that the LSB of K_{NRP-sess} ID is not unique. The peer UE-2 receiving a Direct Security Mode Reject message shall inspect the cause value and, if the cause is related to the session identifier uniqueness then, the UE-2 shall generate a new LSB of K_{NRP-sess} ID and reply to UE-1 again (i.e., UE-2 shall send a Direct Security Mode Command message with the new LSB of K_{NRP-sess} ID). UE_2 shall associate the new LSB of K_{NRP-sess} ID with the security context that is created in step 3. UE-2 shall erase the former LSB of K_{NRP-sess} ID from its memory. On receiving this new Direct Security Mode Command, UE_1 shall process the message from the start of step 4.

If the LSB of KNRP-sess ID is unique, UE_1 shall calculate KNRP-sess and the confidentiality key (if applicable) and integrity key in the same way as UE_2. The confidentiality key, NRPEK, shall be derived in this step if and only if the Chosen_algs includes non-NULL confidentiality algorithm. The integrity protection key, NRPIK, shall be derived in this step if and only if signaling integrity protection is activated for this connection. UE_1 shall check that the returned UE_1 security capabilities and UE_1's signaling security policy are the same as those it sent in step 1. UE_1 shall also check the integrity protection on the message. If both these checks pass, then UE_1 creates a security context to be associated with the K_{NRP-sess} ID. UE_1 is ready to send and receive signaling and message with the new security context. The lower layer shall be provided with the new security context and indication to signal that signaling starting with the Direct Security Mode Complete needs protection with new security context and the signaling messages can be received using the new security context. UE_1 shall send integrity protected and confidentiality protected (if applicable) Direct Security Mode Complete message to UE_2. UE_1 shall form the KNRP-sess ID from the most significant bits it sent in step1 and least significant bits it received in step3. KNRP-sess ID is used to locally identify the security context that is created by this procedure.

At step 5, if the Chosen_algs in step 3 includes a non-NULL integrity algorithm, UE_2 checks the integrity protection on the received Direct Security Mode Complete message. If this passes, UE_2 is now ready to send signaling message and send and receive user plane traffic protected with the new security context. UE_2 can then send integrity protected and confidentiality (if applicable) protected Direct Communication Accept message to UE_1 with the new security context. The lower layer can be provided with an indication before sending the Direct Communication Accept message to indicate that the signaling message starting with the Direct Communication Accept is protected with the new security context and an indication after sending Direct Communication Accept message to indicate that the user plane traffic is protected with the new security context. UE_2 deletes any old security context it has for UE_1.

As discussed above, when path switching is allowed for a particular ProSe service, each of the two or more UE's will set its signaling integrity protection policy to REQUIRED, which will ensure that a secure PC5 connection is established and that future signaling and data exchanged between the two or more UE's in order to negotiate and thereafter switch to the Uu path will be also be protected. Thus, one feature and advantage of the present disclosure is to provide a reliable and protected path switching negotiation process, which may otherwise be vulnerable to corruption, hacking or interference by malicious third parties, for example.

In some embodiments, whether path switching is allowed for a particular ProSe service is determined by a path switching policy that preconfigured by a network node or a service provider or an application. Each UE is informed of and configured in accordance with the path switching policy for each service it is authorized to provide. If path switching is allowed based on the path switching policy of a ProSe service, each UE authorized to provide that service will sets is signaling integrity protection policy for that ProSe service over the PC5 interface to REQUIRED. Thus, one aspect of the present disclosure is that a relationship or association between the path switching policy and the signaling integrity protection policy for a ProSe service is established in order to provide a secure, reliable PC5 connection between UE's providing the ProSe service, and protect subsequent negotiations between the UE's when performing path switching to the Uu interface.

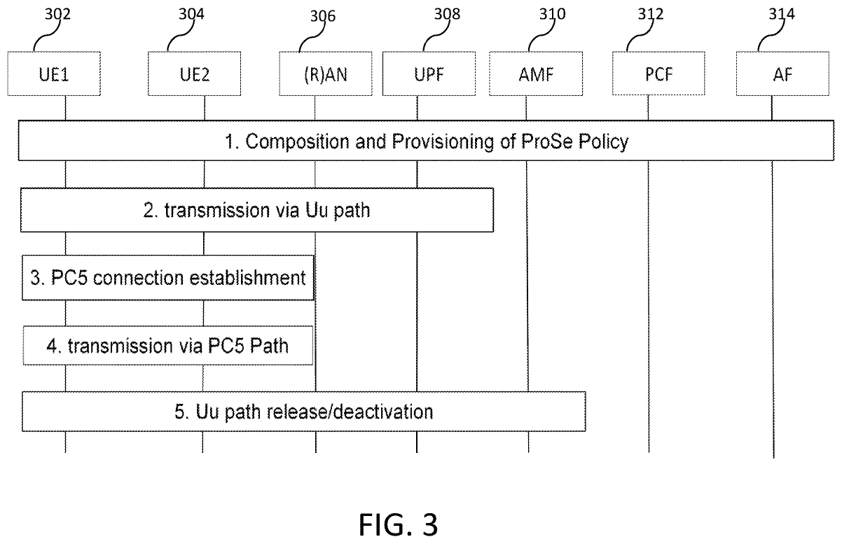

FIG. 3 illustrates a high-level process flow of a process for switching from a Uu path to a PC5 path for direct communications between two UEs, in accordance with some embodiments. As shown in FIG. 3, the process can be implemented by a first UE 302 (hereinafter “UE1”), a second UE 304 (hereinafter “UE2”), and various nodes of a wireless communication network including a Random Access Network (RAN) node 306, a User Plane Function (UPF) node 308, an Access and Mobility Function (AMF) node 310, a Policy Control Function (PCF) node 312 and an Application Function (AF) node 314. As would be understood by those of ordinary skill in the art, the wireless communication network can include other nodes, modules, functions, etc., which are not shown. Referring still to FIG. 3, at step 1, triggered by an AF 314 request, the PCF 312 may provide the path switch policy/parameters for ProSe services to the UEs (including UE1 and UE2) by using the standard procedures. The path switch policy/parameters may include whether each specific service (e.g., Service A, Service B, Service C) is allowed to switch from the Uu path to the PC5 path, and vice versa.

At step 2, UE1 and UE2 have already established PDU Sessions and the Uu path is used for some service data transmission, e.g., Service A, Service B, Service C transmission. Before the Uu path transmission, UE1 and UE2 may have received the path selection policy, which indicates that the Uu path is preferred for some services, for example. It should be noted that the path selection policy is different from the path switch policy, which indicates whether path switching is allowed for each service.

At step 3, UE1 and UE2 can discover each other and one or both can decide it is desirable to establish the PC5 connection for one or more services that allow switching between Uu and PC5 paths. For example, it may be desirable to switch to a PC5, when the Uu signal level is lower than the configured threshold, or a Uu QoS for a service cannot be satisfied, or UE-1 and UE-2 are in close proximity to each other, or it is desirable to offload some traffic from the network, etc. In such situations, UE1 can send a request message to UE2 to switch to the PC5 path and which service(s) to switch based on their path switch policy. The response message from UE2 includes the service(s) from the request message that can be switched as acknowledgement. For example, for UE1, both Service A and Service B are allowed to switch from Uu to PC5, but Service C is not allowed to switch from Uu to PC5, and for UE2, both Service A and Service C are allowed to switch from Uu5 to PC5, but Service B is not allowed to switch from Uu to PC5. In this case, the request will contain Service A and Service B and the response will only contain Service A, resulting in Service A being switched to PC5 and the remaining services continuing to use the Uu path.

In some embodiments, during establishment of the PC5 connection, UE1 and UE2 can each set their respective UP security policies for Service A over the PC5 path to match the UP security policy that was implemented over the Uu path. For example, if the UE's had an active UP security protection for Service A over the Uu path, then each UE should set the UP security policy for Service A over the PC5 path to REQUIRED. If the UEs did not have an active UP security protection for Service A over the Uu path, then each UE should set the UP security policy for Service A over the PC5 path to NOT NEEDED. In some embodiments, the UP security policy for a ProSe service over the Uu path may be set by the network, or by the service provider or a particular application. Thus, when switching to the PC5 path, each UE can set the UP security policy for the ProSe service over the PC5 connection to be the same as that provided over the Uu connection. Thus, continuity of service and security can be maintained. Maintaining security levels during path switching can prevent a bidding down attack from a malicious third party, for example. If two paths have different security policies, the attacker can employ traffic jamming techniques to cause an undesired service change to another path which is not security protected, for example.

Additionally, as discussed above, in accordance with some embodiments, if one or more of the ProSe services is allowed to be switched from the Uu path to the PC5 path, and vice versa, UE1 and UE2 will set their respective signaling integrity protection policy for such ProSe services over the PC5 path to REQUIRED. Thus, in the above-described scenario, UE1 and UE2 can set the signaling integrity protection policy for Service A over the PC5 path to REQUIRED. In this way, if UE1 and UE2 subsequently decide to switch signaling for Service A from the PC5 path back to the Uu path, signaling for negotiations between UE1 and UE2 to perform the path switching will be protected, as discussed above.

At step 4, UE1 and UE2 transmit the data of the Service A via the PC5 path. At step 5, UE1 and UE2 can still transmit the data of the unswitched service(s) via the Uu path. However, the PDU session(s) over Uu path may be released or deactivated if no service uses them.

FIG. 4 illustrates a high-level process flow of a process for establishing a PC5 connection for communications between two UEs, including negotiations between the two UEs, and thereafter switching from the PC5 path to a Uu path for direct communications between the two UEs, in accordance with some embodiments. As shown in FIG. 4, the process can be implemented by a first UE 402 (hereinafter “UE#1”), a second UE 404 (hereinafter “UE#2”), and various nodes of a wireless communication network including a Random Access Network (RAN) node 406, an Access and Mobility Function (AMF) node 408, a Session Management Function (SMF) node 410, a Policy Control Function (PCF) node 412 and an Application Function (AF) node 414. As would be understood by those of ordinary skill in the art, the wireless communication network can include other nodes, modules, functions, etc., which are not shown.

The process illustrates in FIG. 4 provides a UE negotiation-based mechanism for direct communication path switching between PC5 and Uu paths or interfaces, in accordance with some embodiments of the present disclosure. Before performing the path switch, two UEs having a PC5 connection negotiate the triggers of path switching and what service or QoS flows need to be switched. Once the negotiated triggers are satisfied, the 2 UEs perform the path switching between PC5 to Uu directly. To reduce the service interruption, in some embodiments, the two UEs may perform corresponding Uu session setup/activation in advance before the UE negotiation-based mechanism over the PC5 path for the path switching from PC5 to Uu interface is performed or completed. Conversely, for path switching from the Uu to PC5 interface, the two UEs can establish the PC5 link in advance, then negotiate the ProSe services to be switched over the established PC5 link. After that, the two UEs can perform the path switching based on the negotiated result.

During the negotiation procedure, the two UEs may negotiate:
Which ProSe service to be switched;
Which QoS flow(s) to be switched;
Triggers of path switching from PC5 to Uu about:
Threshold of PC5 signal level;
Threshold of QoS requirement/parameters.

In some embodiments, the negotiation can be triggered by UE implementation based on its own service requirement perspective. In further embodiments, granularity of this solution for path switching can be based service level and QoS flow level considerations and factors. For example, due to UE mobility or other conditions (e.g. under congestion control, mobility restriction), the UE may not be able to perform path switching. In this case, the UE may notify the peer UE of deactivating the negotiated triggers or UE ProSe policy of path switching to avoid the peer UE performing path switch solely.

Referring still to FIG. 4, at step 1, service authorization and provisioning are performed by the network for each of UE#1 and UE#2 in accordance with standard procedures. For example, the procedures for service authorization and provisioning to each UE may be initiated by the PCF node 412, in accordance with standard procedures. If the UE is configured for 5G ProSe capability and is authorized to use 5G ProSe service based on subscription data, the AMF 408 selects the PCF 412 which supports 5G ProSe Policy/Parameter provisioning and establishes a UE policy association with the PCF 412 for 5G ProSe Policy/Parameter delivery.

At step 2, UE#1 and UE#2 may have an established PC5 connection which are transferring service data with each other over PC5 QoS flows. In accordance with some embodiments, if one or more of the ProSe services is allowed to be switched from the Uu path to the PC5 path, and vice versa, during or after PC5 connection establishment, UE#1 and UE#2 can set their respective signaling integrity protection policy for such ProSe services over the PC5 path to REQUIRED. Thus, if UE#1 and UE#2 subsequently decide to switch signaling for the one or more services from the PC5 path to the Uu path, signaling integrity for negotiations and patch switching between UE#1 and UE#2, as described in further detail below in steps 3-8, will be protected.

At step 3, considering to avoid service interruption, UE#1 and UE#2 may consider the path switch from PC5 to Uu. In order to have a uniform understanding for the path switch, the two UEs will negotiate the path switching services, QoS flows and the triggers of the service or QoS flows to be switched. UE #1 sends a Path switching negotiation request which may include the ProSe ID, PC5 QoS flows IDs, Threshold of PC5 signal level, or Threshold of QoS requirement/parameters. This step can be combined with PC5 unicast connection establishment/modification procedure.

At step 4, after receiving the above request from UE#1, UE#2 determines the services, QoS flows triggers and related triggers based on the Path switching negotiation request from the UE#1. The UE#2 responds to the UE #1 with a Path switching negotiation response including the accepted ProSe ID, PC5 QOS flows IDs, Threshold of PC5 signal level, or Threshold of QoS requirement/parameters.

Next at step 5, based on the negotiation, the UE#1 and UE#2 may perform the Uu path preparation procedure. UE1 and UE2 triggers PDU Session establishment/modification procedure to make the Uu path ready for the corresponding ProSe services or PC5 QoS flows transmission. In steps 6, 7a and 7b, when the negotiated triggers/conditions are satisfied, the UE#1 and UE#2 transmit the data of the ProSe services of accepted ProSe IDs or the PC5 QoS flows of the accepted PC5 QoS flow IDs to the Uu path.

In some embodiments, in order to establish the Uu link at steps 7a and 7b, each of UE#1 and UE#2 initiates a PDU Session Establishment procedure by the transmission of a NAS message containing a PDU Session Establishment Request message to the AMF 408. In addition to conventional parameters and information contained in the PDU Session Establishment Request message, such as a PDU session ID, Requested PDU Session Type, a Requested Session and Service Continuity (SSC) mode, 5G Session Management (5GSM) Capability, Police Communications Operator (PCO), SM PDU DN Request Container, an updated PDU Session Establishment Request message may contain one or more additional parameters which notify the AMF 408 that (1) the UEs are switching from a PC5 interface to the Uu interface and (2) the UP Security Policy over the PC5 link for the service(s) being switched. As used herein, the term “UP Security Policy” can include only the UP integrity protection policy, only the UP confidentiality protection policy, or both, as defined above. The AMF 408 will then pass on this new information, along with conventional information, to the selected SMF 410, which then processes the information to either accept or reject the PDU Session Establishment request.

In some embodiments, the SMF 410 is configured to reject a PDU session request that is being switched from the PC5 path when the PC5 UP Security Policy for the service being switched does not match the Uu path UP Security Policy for that service, or the PC5 UP Security Policy (e.g., REQUIRED) cannot be currently supported by the network due to insufficient availability of resources, poor signal quality, too much traffic, etc. In this way, communications between UE#1 and UE#2 will not be switched from the PC5 path to the Uu path if such a switch would result in a decrease UP security protections.

Finally, at step 8, after the steps 7a and 7b are completed, if the PDU session is granted, UE1 and UE2 may release the PC5 connection, using conventional or standard procedures.

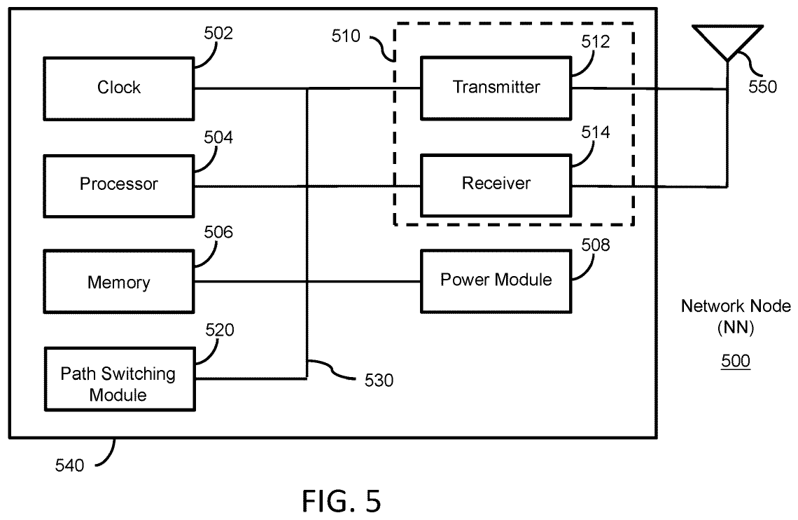

FIG. 5 illustrates a block diagram of a network node (NN) 500, in accordance with various embodiments of the invention. The NN 500 can be a wireless communication node that is configured to implement the various methods and processes described herein. In some embodiments, the NN 500 may be wireless communication node such as an RAN, AMF, SMF, PCF or AF, as described herein. In other embodiments, the NN 500 may be a wireless communication device such as a user equipment device (UE), as described herein. As shown in FIG. 5, the NN 500 includes a housing 540 containing a system clock 502, a processor 504, a memory 506, a transceiver 510 comprising a transmitter 512 and receiver 514, a power module 508, and a path switching module 520.

In this embodiment, the system clock 502 provides the timing signals to the processor 504 for controlling the timing of all operations of the NN 500. The processor 504 controls the general operation of the NN 500 and can include one or more processing circuits or modules such as a central processing unit (CPU) and/or any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable circuits, devices and/or structures that can perform calculations or other manipulations of data.

The memory 506, which can include both read-only memory (ROM) and random access memory (RAM), can provide instructions and data to the processor 504. A portion of the memory 506 can also include non-volatile random access memory (NVRAM). The processor 504 typically performs logical and arithmetic operations based on program instructions stored within the memory 506. The instructions (a.k.a., software) stored in the memory 506 can be executed by the processor 504 to perform the methods described herein. The processor 504 and memory 506 together form a processing system that stores and executes software. As used herein, “software” means any type of instructions, whether referred to as software, firmware, middleware, microcode, etc. which can configure a machine or device to perform one or more desired functions or processes. Instructions can include code (e.g., in source code format, binary code format, executable code format, or any other suitable format of code). The instructions, when executed by the one or more processors, cause the processing system to perform the various functions described herein.

The transceiver 510, which includes the transmitter 512 and receiver 514, allows the NN 500 to transmit and receive data to and from an external network node (e.g., a RAN, AMF, PCF, etc.). An antenna 550 is typically attached to the housing 540 and electrically coupled to the transceiver 510. In various embodiments, the NN 500 includes multiple transmitters, multiple receivers, and multiple transceivers. In some embodiments, the antenna 550 includes a multi-antenna array that can form a plurality of beams each of which points in a distinct direction in accordance with MIMO beamforming techniques.

The path switching module 520 may be implemented as part of the processor 504 programmed to perform the functions herein, or it may be a separate module implemented in hardware, firmware, software or a combination thereof. In some embodiments, the path switching module 520 is part of a UE and is configured to set security policies, conduct negotiations with a peer UE, and switch/establish PC5 and Uu connections, as described herein. In accordance with various embodiments, the path switching module 520 can be implemented as software (i.e., computer executable instructions) stored in a non-transitory computer-readable medium that when executed by processor 504, transform the processor 504 into a special-purpose computer to perform the path switching operations described herein.

The various components and modules discussed above within housing 540 are coupled together by a bus system 530. The bus system 530 can include a data bus and, for example, a power bus, a control signal bus, and/or a status signal bus in addition to the data bus. It is understood that the modules of the NN 500 can be operatively coupled to one another using any suitable techniques and mediums. It is further understood that additional modules (not shown) may be included in the NN 500 without departing from the scope of the invention.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, signal, etc. that is physically constructed, programmed, arranged and/or formatted to perform the specified operation or function.

Furthermore, a person of ordinary skill in the art would understand that various illustrative logical blocks, modules, devices, components and circuits described herein can be implemented within or performed by an integrated circuit (IC) that can include a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A processor programmed to perform the functions herein will become a specially programmed, or special-purpose processor, and can be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method performed by a wireless communication device, the method comprising:
determining whether a service is allowed to switch between at least two different communication paths based on a path switching policy associated with the service; and
when the service is allowed to switch between the at least two different communication paths, setting a signaling integrity protection policy for the service to REQUIRED.

2. The method of claim 1, wherein the service comprises a proximity-based (ProSe) service.

3. The method of claim 2, wherein the at least two different communications paths comprise a Uu path and a PC5 path.

4. The method of claim 3, wherein the wireless communication device has an established communication link over the PC5 path with a peer wireless communication device, and the service is allowed to switch from the PC5 path to the Uu path, the method further comprising:
performing a negotiation process with the peer wireless communication device, wherein the negotiation process is protected by the REQUIRED signal integrity protection;
after successful completion of the negotiation process, sending a request to a wireless communication node to establish a connection over the Uu path; and
after establishing the connection over the Uu path, switching from the PC5 path to the Uu path.

5. The method of claim 4, wherein the REQUIRED signal integrity protection is maintained for signaling and data associated with the ProSe service over the Uu path.

6. The method of claim 3, wherein the wireless communication device has an established communication link over the Uu path with a peer wireless communication device, and the service is allowed to switch from the Uu path to the PC5 path, the method further comprising:
if the wireless communication device has an active User Plane (UP) security protection for the service over the Uu path, setting the UP security protection policy for the service to REQUIRED for the PC5 path; or
if the wireless communication device does not have an active UP security protection for the service over the Uu path, setting the UP security protection policy for the service to NOT NEEDED for the PC5 path.

7. The method of claim 6, further comprising:
negotiating with the peer wireless communication device to establish a security protection level for communications associated with the service over the PC5 path in accordance with the UP security protection policy set by the wireless communication device; and
establishing communications with the peer wireless communication device over the PC5 path in accordance with the established security protection level.

8. The method of claim 3, wherein the wireless communication device has an established communication link over the PC5 path with a peer wireless communication device, and the service is allowed to switch from the PC5 path to the Uu path, the method further comprising:
sending an updated PDU Session Establishment Request message to a wireless communication node in order to establish a communication link over the Uu path, wherein the updated PDU Session Establishment Request message contains one or more parameters that notify the wireless communication node that the wireless communication device is switching from the PC5 interface to the Uu interface and the UP Security Policy over the PC5 link for the service being switched.

9. The method of claim 8, wherein the UP Security Policy comprises: a UP integrity protection policy; or a UP confidentiality protection policy;
or both the UP integrity protection policy(a) and the UP confidentiality protection policy(b).

10. A method performed by a wireless communication device, the method comprising:
establishing communications over a first path with a peer wireless communication device to exchange signaling associated with a service;
negotiating with the peer wireless communication device to switch from the first path to a second path;
establishing communications over the second path between the wireless communication device and the peer wireless communication device; and
setting a User Plane (UP) security policy for signaling associated with the service over the second path during the establishing communication over the second path, wherein:
when the wireless communication device has an active UP security protection for the service over the first path, the wireless communication device sets the UP security protection policy for the service to REQUIRED for the second path; and
when the wireless communication device does not have an active UP security protection for the service over the first path, the wireless communication device sets the UP security protection policy for the service to NOT NEEDED for the second path.

11. The method of claim 10, wherein the first path comprises a Uu path and the second path comprises a PC5 path.

12. The method of claim 10, wherein the UP Security Policy comprises: a UP integrity protection policy; or a UP confidentiality protection policy; or both the UP integrity protection policy and the UP confidentiality protection policy.

13. The method of claim 10, further comprising:
negotiating with the peer wireless communication device to establish a security protection level for communications associated with the service over the PC5 path in accordance with the UP security protection policy set by the wireless communication device; and
establishing communications with the peer wireless communication device over the PC5 path in accordance with the established security protection level.

14. The method of claim 13, further comprising:
after establishing communications with the peer wireless communication device over the PC5 path, setting a signal integrity protection policy for the service to REQUIRED;
determining whether other services authorized for the wireless communication device and the peer wireless communication device allow path switching between the PC5 and Uu paths; and
for any other authorized services that allow the path switching, setting the signal integrity protection policy for each of the other services to REQUIRED.

15. The method of claim 14, further comprising setting a signal confidentiality protection policy for the service and any other authorized services that allow the path switching to REQUIRED.

16. A method performed by a wireless communication device, the method comprising:
establishing communications over a PC5 path with a peer wireless communication device, wherein the communications are associated with a service;
negotiating with the peer wireless communication device to determine whether to switch further communications associated with the service from the PC5 path to a Uu path;
after determining to switch the further communications from the PC5 path to the Uu path,
establishing communications over the Uu path with the peer wireless communication device, wherein the establishing communications over the Uu path comprises:
transmitting a request message to a wireless communication node, wherein the request message requests establishment of communications over the Uu path and contains at least one parameter that informs the wireless communication node that the further communications will be switched from the PC5 path to the Uu path, and informs the wireless communication node of a User Plane (UP) security state of communications associated with the service over the PC5 path, wherein the UP security state comprises active or inactive.

17. The method of claim 16, wherein the wireless communication node determines to reject or accept the request message based at least in part on the at least one parameter.

18. The method of claim 16, further comprising at least one of the following:
after establishing communications over the PC5 path with a peer wireless communication device, setting a signal integrity protection policy for the service to REQUIRED;
determining whether other services authorized for the wireless communication device and the peer wireless communication device allow path switching between the PC5 and Uu paths; and for any other authorized services that allow the path switching, setting the signal integrity protection policy for each of the other services to REQUIRED;
setting a signal confidentiality protection policy for the service and any other authorized services that allow the path switching to REQUIRED.

19. (canceled)

20. (canceled)

21. A wireless communication device, comprising:
at least one processor; and
a memory, coupled to the at least one processor, the memory storing processor-executable instructions therein, that when execute by the at least one processor perform the method of claim 1.

22. A non-transitory computer-readable medium storing computer-executable instructions therein that when executed by a computer perform the method of claim 1.
